(19) United States
(12) Patent Application Publication
(10) Pub. No.: US 2013/0173488 A1
(43) Pub. Date: Jul. 4, 2013

(54) Methods and Systems for Facilitating Movement of Articles of Freight

(71) Applicant: R+L Carriers, Inc., Wilmington, OH (US)

(72) Inventor: Chris Deck, Wilmington, OH (US)

(73) Assignee: R+L CARRIERS, INC., Wilmington, OH (US)

(21) Appl. No.: 13/788,261

(22) Filed: Mar. 7, 2013

Related U.S. Application Data
(62) Division of application No. 12/785,553, filed on May 24, 2010.

(51) Int. Cl. G06Q 10/08; G06Q 50/30

(52) U.S. Cl. CPC G06Q 10/0833; G06Q 50/30
USPC 705/333

(57) ABSTRACT

Methods and systems for facilitating movement of articles in freight are disclosed. One method comprises reading an article marker comprising article data identifying the article; transmitting the article data to a computing device in electrical communication with a database comprising one or more shipping rules related to the article; associating the article with the one or more shipping rules; reading a second location marker comprising second location data identifying the second location; transmitting the second location data to the computing device; determining whether movement of the article to the second location is consistent with the one or more shipping rules; transmitting a message from the computing device to an annunciator indicating whether movement of the article is consistent with the one or more shipping rules; and setting a state of the annunciator, based on the message.

### RELATED APPLICATION

This application is a divisional of U.S. patent application Ser. No. 12/785,553 filed May 24, 2010, the entire disclosure of which is hereby incorporated by reference.

### TECHNICAL FIELD

The present invention generally relates to methods and systems for facilitating movement of articles of freight and, more specifically, for determining and indicating whether movement of an article is consistent with one or more shipping rules.

### BACKGROUND

As background, freight carriers transport articles from a sender to a receiver. During transportation, an article may travel on several transport vehicles and may be temporarily stored in a number of different warehouse or distribution facilities. For example, an article staged in a one distribution center may need to be placed on a truck going to another distribution center. Because of the multiple movements of the article during shipping, it is possible to move the article to an incorrect transport vehicle or distribution facility.

In addition, specific rules or restrictions may be placed on an article of freight, either by the freight carrier, the sender, the receiver, or federal, state, or local governments. As an example, if the article contains a hazardous material, it may be desirable to prevent this article from being transported with other types of materials. As another example, if the article must be delivered to the receiver accompanied by a second article, it may be desirable to make sure that both articles travel together.

Therefore, a need exists for a freight carrier to facilitate movement of articles in freight and determine in real time whether movement of the article from one location to another location is consistent with a set of shipping rules related to that article. A visible, audible, or tactile annunciator may notify an operator whether the movement is consistent or not consistent and may assist the freight carrier in reducing errors.

### SUMMARY

In one embodiment, a method for indicating whether movement of an article from a first location to a second location is consistent with one or more shipping rules comprises: reading an article marker comprising article data identifying the article; transmitting the article data to a computing device, wherein the computing device is in electrical communication with a database comprising one or more shipping rules related to the article; using the computing device to associate the article, based at least in part on the article data, with the one or more shipping rules in the database; reading a second location marker comprising second location data identifying the second location; transmitting the second location data to the computing device; using the computing device to determine whether movement of the article to the second location is consistent with the one or more one or more shipping rules, based at least in part on the second location data; transmitting a message from the computing device to an annunciator, wherein the message indicates whether movement of the article to the second location is consistent with the one or more shipping rules; and setting a state of the annunciator, based on the message.

In another embodiment, a method for determining whether to move an article disposed at a first location comprises: reading an article marker comprising article data identifying the article; transmitting article data to a computing device, wherein the computing device is in electrical communication with a database comprising one or more shipping rules related to the article; using the computing device to associate the article, based at least in part on the article data, with the one or more shipping rules in the database; reading a first location marker comprising first location data identifying the first location; transmitting first location data to the computing device; using the computing device to determine whether to move the article from the first location, based at least in part on the one or more shipping rules and the first location data; transmitting a message from the computing device to an annunciator, wherein the message indicates the determination of whether to move the article from the first location; and setting a state of the annunciator, based on the message.

In yet another embodiment, a method for indicating whether movement of an article from a first location to a second location is consistent with one or more shipping rules comprises: receiving into a computing device article data identifying the article, wherein the computing device is in electrical communication with a database comprising one or more shipping rules related to the article; associating the article, based at least in part on the article data, with one or more shipping rules in the database; receiving into the computing device second location data identifying the second location; determining, by the computing device, whether movement of the article to the second location is consistent with the one or more shipping rules, based at least in part on the second location data; and transmitting a message from the computing device to an annunciator, wherein the message indicates whether movement of the article to the second location is consistent with the one or more shipping rules.

In still another embodiment, a method for indicating whether to unload a transport vehicle disposed at a location, the method comprising: reading a transport vehicle marker comprising transport vehicle data identifying the transport vehicle; transmitting transport vehicle data to the computing device, wherein the computing device is in electrical communication with a database comprising one or more shipping rules related to the transport vehicle; reading a location marker comprising location data identifying the location; using the computing device to determine whether to unload the transport vehicle, based at least in part on the one or more shipping rules and the location data; transmitting a message from the computing device to an annunciator, wherein the message indicates the determination of whether to unload the transport vehicle; and setting a state of the annunciator, based on the message.

In yet another embodiment, a system for indicating whether movement of an article from a first location to a second location is consistent with one or more shipping rules comprises: an article marker, a second location marker, a reader, a computing device, a database, and an annunciator, wherein the article marker is mechanically coupled to the article and comprises article data identifying the article; the second location marker is associated with the second location and comprises second location data identifying the second location; the reader is operable to read the article data from the article marker and the second location data from the second location marker and transmit the article data and second location data to the computing device; the computing device is communicatively coupled to the database comprising one or more shipping rules related to the article; the computing device is operable to associate the article, based at least in part on the article data, with the one or more shipping rules in the database; the computing device is operable to determine whether movement of the article to the second location is consistent with the one or more shipping rules, based at least in part on the second location data; the computing device is operable to transmit a message to the annunciator indicating whether movement of the article to the second location is consistent with the one or more shipping rules; and the annunciator is operable to indicate whether movement of the article to the second location is consistent with the one or more shipping rules.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 depicts a system for facilitating movement of articles of freight according to one or more embodiments shown and described herein; and

FIGS. 2-5 depict methods for facilitating movement of articles of freight according to one or more embodiments shown and described herein.

### DETAILED DESCRIPTION

The embodiments described herein generally relate to methods and systems for facilitating movement of articles of freight and, more specifically, for determining and indicating whether movement of an article from a first location to a second location is consistent with one or more shipping rules related to the article. Other embodiments described herein relate to methods for determining whether to move an article disposed at a first location, based on the identity of the first location and one or more shipping rules related to the article.

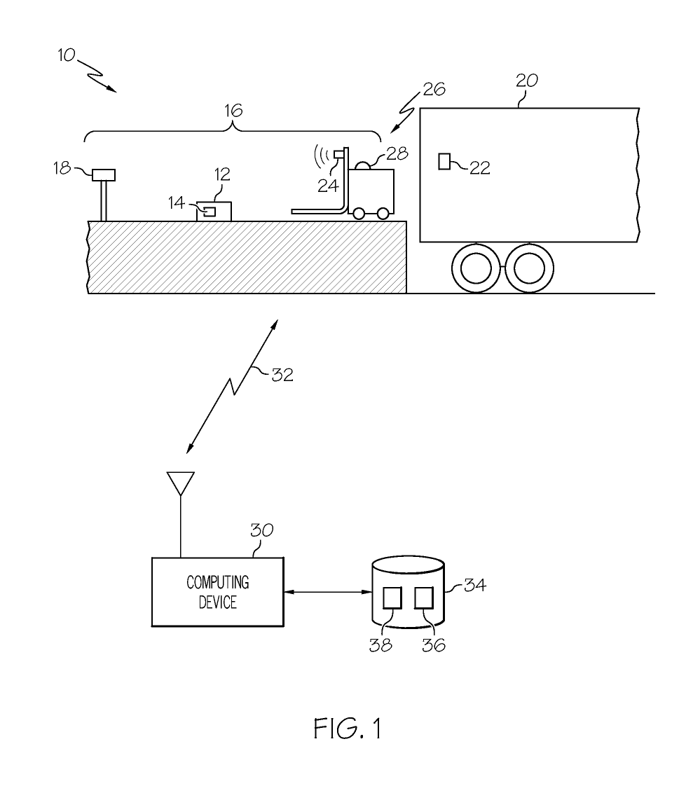

FIG. 1 depicts an exemplary system 10 which may facilitate movement of an article 12 of freight from a first location 16 to a second location 20. The system 10 may also be operable to retrieve information about the article 12. A brief description of the system components is described below. The article 12 may have an article marker 14 affixed to it which identifies the article. The first location 16 may have a first location marker 18 either affixed to or otherwise located near the first location 16 such that the first location marker identifies the first location 16. Similarly, the second location 20 may have a second location marker 22 either affixed to or otherwise located near the second location 20 such that the second location marker 22 identifies the second location 20. The reader 24 may be operable to read the article marker 14, the first location marker 18, and/or the second location marker 22. The reader 24 may be mechanically coupled to a forklift 26 operable to lift and move the article from the first location 16 to the second location 20. As one alternative, the reader 24 may be a portable hand-held device. The annunciator 28 may be mechanically coupled to the forklift 26 and may be operable to indicate to a person whether movement of the article from the first location 16 to the second location 20 is consistent with one or more shipping rules 36. As will be described herein, the annunciator 28 may comprise a variety of devices and or techniques in order to provide the indication.

Continuing to refer to FIG. 1, the system 10 may further comprise a communication link 32 which permits communication between the reader 24 and a computing device 30. By using the communication link 32, the reader 24 may be operable to transmit identifying information about the article, the first location, and/or the second location to the computing device. Similarly, the computing device 30 may transmit messages to the reader 24 and/or the annunciator 28 via the communication link 32. The computing device 30 may be electrically coupled to a database 34, which may comprise one or more shipping rules 36 related to the article 12. In some embodiments, the database 34 may also comprise information 38 about the article 12. A detailed description of these components is now provided.

The article 12 of freight may comprise a container, a box, an envelope, a parcel, a package, a carton, a canister, or any other equivalent which may be shipped by a freight carrier. The article may be large or small and may comprise a number of smaller constituent packages bound together. The article 12 may comprise one or more handling units, such as for example “skids.” Each handling unit may be independently movable with respect to each other, although collectively they may be considered one article by the system 10. As such, each handling unit may comprise a handling unit marker which may allow the system 10 to identify each handling unit. Thus, the article marker may comprise the handling unit markers associated with the handling units (which, correspondingly, are associated with the article).

The article 12 may be disposed at a first location 16. The freight carrier may wish to move the article from the first location 16 to the second location 20 as part of the article's itinerary of transporting the article from the sender to the receiver. Although the embodiment of FIG. 1 shows the first location 16 as being a dock and the second location 20 as being a transport vehicle (e.g., a truck), it is contemplated that either the first location 16 or second location 20 may include other sites as well, including but not limited to a warehouse, a distribution center, or any particular area therein. Furthermore, the first location 16 or second location 20 may also include other types of transport vehicles, such as train cars, planes, ships, semi tractor trailers, and so forth, including particular areas therein (e.g., a particular location within the truck). As an example, the first location 16 may be a first truck, and the second location 20 may be a second truck. As another example, the first location 16 may be a dock, and the second location 20 may be a specific staging area in the warehouse. Other sites for the first location and the second location are contemplated as well.

The article 12 may have an article marker 14 which may comprise data identifying the article 12. Examples of article markers include serial numbers, hand-written markers, bar codes, radio frequency identification (RFID) devices, and inductive identifiers. Other types of markers may be used, as is known in the art. The article marker 14 may be affixed to the article 12 such that it travels with the article during its movement. Alternatively, the article marker 14 may be affixed to a device or structure associated with the article 12, such as a carrier or a pallet. The first location marker 18 and the second location marker 22 may identify the first location 16 and the second location 20, respectively, and may comprise similar types of identifiers as the article marker (e.g., serial numbers, bar codes RFID, and inductive identifiers). By way of example and not limitation, a marker 14, 18, 22 may simply comprise a string of alpha-numeric characters which permits the article or the location to be identified. This string of characters may be printed (so as to be seen by a user, e.g., on a label), may be encoded in a bar code, or may be electronically stored in an RFID device or inductive identifier. Alternatively, the markers 14, 18, 22 may comprise binary symbols or characters, such as zeros and ones. Other methods of identification may be used as well, as is known in the art. Furthermore, the marker 14, 18, 22 may also comprise additional information that may not necessarily relate to identification (e.g., weight, dimensions, condition, movement/handling data, maintenance information).

The article marker 14 may further comprise one or more of the one or more shipping rules (to be described hereinafter), such as a subset of the shipping rules 36 located in the database 34. For example, the article marker 14 may comprise an indication of the priority of the article or may comprise some or all of the shipping itinerary. The article marker 14 may be configured such that the article data and the shipping rules contained therein are capable of being read at the same time. The shipping rules stored on the article marker 14 may be subsequently be used to determine whether movement of the article 12 is consistent with these shipping rules. Furthermore, if the article marker 14 is capable of receiving and storing data (such as the case with many RFID devices), the system 10 may be configured to not only read the article marker 14 and its constituent article data, shipping rules, and/or other information, but also write or update the shipping rules or other information in the article marker 14. This may be useful, for example, when storing some or all of the shipping rules 36 directly on the article marker; in this case, the shipping rules 36 may change as the article 12 progresses toward its destination location, and the shipping rules 36 stored on the article marker 14 may reflect these changes in real time. As another example, the article markers comprise other information, such as time stamps, route history, user, location, destination location, etc. In this instance, some information may be static (i.e., not subject to change), such as the weight of the article or its destination location. However, other information stored on the article marker 14 may be subject to change, such as the route history, time stamps, or whether it is damaged. Accordingly, the system 10 (via the reader 24, as explained below) may be configured to either automatically or manually write this information to the article marker 14 in real time. In order to facilitate this function, the reader 24 may be capable of writing data to the article marker 14 (as well as, of course, reading data from it). The same reading/writing capability may be incorporated into the location markers 18, 22 as well. In yet another embodiment, the article marker may comprise one or more sensors capable of storing associated data (e.g., temperature, vibration, orientation, humidity).

Similarly, a manifest associated with a transport vehicle may contain some or all of the shipping rules as well as other information, such as information related to the transport vehicle itself or to any of the articles contained on the transport vehicle. In order to store the shipping rules and/or other information, the manifest (which may be in paper form) may have a readable memory device, such as a bar code label or an RFID device. Other similar devices may be used as well. The system 10 may read the readable memory device and transmit the shipping rules and/or other information contained therein to the computing device, which may supplement the shipping rules and/or other information to those already stored in the database. This may be helpful when the database is unavailable (e.g., the server or a computer link is malfunctioning) such that the system 10 may be able to receive sufficient shipping rules from the readable memory device so as to appropriately decide whether movement of the article is consistent with the one or more shipping rules. The readable memory device associate with the manifest may be read by the same reader which reads the article marker and/or other markers. Alternatively, a different reader may be used. In yet another embodiment, the readable memory device may also comprise part of the location marker 22. In a further embodiment, the location marker may comprise one or more sensors capable of storing associated data (e.g., temperature, humidity).

The location markers 18, 22 may be placed at or near their respective locations so as to identify that particular location to the system 10 (through the act of reading the location marker). As such, the location markers 18, 22 may identify any place or thing which is used in the course of shipping the article, such as a transport vehicle, a dock location, a weigh station, an inspection station, a measurement station, and/or a staging area (e.g., for temporarily storing delayed freight). For example, if the first location 16 is a dock, the first location marker 18 may be placed on (or embedded in) the dock door, wall of the dock, the floor of the dock, or any other structure located near or at the dock, such that the first location marker 18 is capable of identifying the first location 16. The same may be said for the second location marker 22, as well as any of the sites which may be used as the first or second locations. As another example, if the second location 20 is a transport vehicle, the second location marker 22 may be placed on (or embedded in) a door of the transport vehicle, a wall of the transport vehicle, or any other structure associated therewith, such that the second location marker 22 is capable of identifying the second location 20. It is contemplated that the location markers may be positioned on (or in) other suitable structures as well.

A reader 24 may be used to read the article marker 14, the first location marker 18, readable memory device of a manifest, and/or the second location marker 22. In one embodiment, the same reader 24 may be used to read all the markers 14, 18, 22. Alternatively, one type of reader 24 may be used to read the article marker 14, and another type of reader 24 may be used to read the first or second location marker 18, 22. For example, a bar code scanner may be used to read the article marker, and an RFID scanner may be used to read the second location marker 22. The reader 24 may be configured to transmit data read from the article marker, the first location marker, or the second location marker to a computing device 30. The reader 24 may be a hand-held reader so as to be able to be manipulated by a user. As one alternative, the reader 24 may be mounted to a forklift 26 or other similar device, so that any one or all of the markers (i.e., article marker 14, first location marker 18, and second location marker 22) may be automatically read by the reader. As still another alternative, the reader 24 may be mounted to a forklift 26 or a dock door, but may be removable by a user and used as a hand-held reader, if required. If the marker 14, 18, 22 is a visual label which can simply be read by a human, the data from the marker may be manually entered into the reader. This may also be done, for example, if the marker is damaged and cannot be read by the normal method. In another embodiment, data from the marker 14, 18, 22 may be relayed to an operator in communication with the computing device. As an example, a person may visually inspect the marker, contact an operator by phone, and pass the marker data to the operator who enters it into the computing device.

In addition to reading the markers 14, 18, 22, the reader 24 may be configured, as discussed above, to write information to them. In the case of RFID, the markers 14, 18, 22 may be capable of receiving information from the reader 24 and storing the information therein. The reader 24 may also allow the user (i.e., a person using the reader, moving the article, etc.) to be identified through, for example, a readable badge. Alternatively, the reader 24 may have an input device so as to allow the user to login to the system 10 via the reader 24 by using a username/password. Other techniques of identifying the user may be used as well. By knowing the identity of the user, the system 10 may be configured to measure his/her performance characteristics, such as how long he/she takes to load a transport vehicle, and so forth. In addition, this data can be utilized for chain of custody information as well as for investigations into damage and/or loss of articles.

Although FIG. 1 depicts the article 12 being moved with a forklift 26, it is contemplated that movement of the article may be performed by a number of methods, including but not limited to moving the article by hand, dolly, conveyor, crane, or pallet jack. Other methods of moving the article may be employed as well. The reader 24 in FIG. 1 is shown as being attached to the forklift 26 and automatically reading the article when it is picked up. However, when using a device to move the article other than a forklift, the reader 24 may also attached to any of these devices as well. Alternatively, the reader 24 may be hand held or wearable so that an operator may read the article marker before, during, or after its movement. Although the reading of the markers 14, 18, 22 may be automatic, as discussed herein, it may also be manually performed. For example, the reader 24 may be mounted to the forklift 26, but the forklift operator may have to manually cause the reader to read the first and/or second location markers. The reader may also be mounted to a door of the dock or the transport vehicle. Furthermore, two or more readers may be used. As an example, an operator may use a hand-held reader to read the article marker, and a second reader may be mounted on or near the truck door.

The data read by the reader 24 (identifying the article 12, the first location 16, and/or the second location 20) may be transmitted to a computing device 30 by a communication link 32, as shown in FIG. 1. The communication link 32 may be a wireless network, a wired network, or a combination thereof. In one embodiment, the communication link 32 may be a wireless network, such as Bluetooth®, Zigbee®, a wireless computer network (i.e., IEEE 802.11), or a cellular-data network, etc. In another embodiment, communication link may be a wired network, such as Ethernet or a proprietary network. It is contemplated that the communication link 32 may comprise a combination of one or more networks. For example, the reader 24 may wirelessly transmit the data to an intermediate device (e.g., a local server) which may subsequently transmit the data to the computing device 30 via a wired network. Other suitable methods may be used to transmit the data, as is known in the art.

The computing device 30 may comprise a personal computer, a server, a dedicated machine, or other suitable device. In one embodiment, the computing device may comprise a server electrically connected to a computing network. In another embodiment, the computing device may comprise a dedicated machine which may either be embedded in the reader 24 or disposed on the forklift 26 (or other lifting device). Other types of computing devices may be used as is known in the art or yet to be discovered. The computing device 30 may be in electrical communication with a database 34 comprising the shipping rules 36 and article information 38. The database 34 may be disposed within the computing device or may be separate from the computing device. In one embodiment, the database 34 may be an enterprise database management system or “cloud” hosted system, and the like, which may be electrically coupled to the computing device via a computer network, such as Ethernet or the Internet.

In one embodiment, the computing device 30, at least a portion of the database 34, and the annunciator 28 may reside on the reader 24. This structure may permit the reader 24 to autonomously read the article marker 14, transmit the article data to the computing device 30 (located within the reader), associate the article 12 with one or more shipping rules 36 in the database 34, read a second location marker 22, transmit the second location data to the computing device 30, determine whether movement of the article 12 to the second location is consistent with the one or more shipping rules 36 and information about the article 38, transmit a message to the annunciator 28 (indicating whether movement of the article 12 to the second location is consistent with the one or more shipping rules), and set a state of the annunciator 28 based on the message. This embodiment may be used, for example, when the communication link 32 to a primary database is unavailable or otherwise not functioning. The reader 24 may comprise all or a portion of the database 34, such that all or a portion of the shipping rules 36 and/or information about the article 38 are stored on the reader 24. As an example, the reader 24 may comprise a portion (i.e., a subset) of the database 34 such that the portion on the reader 24 comprises only the shipping rules 36 related to articles on a specific transport vehicle. In this fashion, a specific reader 24 may only comprise a portion of the shipping rules 36 necessary for its operation at a certain dock location or when loading/unloading certain transport vehicles.

In another embodiment, a portable hand-held computer may comprise a reader configured to read the article marker and/or the location markers, the annunciator, the computing device, and at least a portion of the database, including at least one of the one or more shipping rules. Such a hand-held computer may be carried by the person moving the article such that the hand-held computer can easily be manipulated by the person when reading the article marker and/or location markers. This type of computer may permit a “stand alone” operation since all of the elements necessary to determine whether movement of the article is consistent with one or more of the shipping rules is contained within the computer. In order to keep its internally-stored shipping rules up to date, the computer may occasionally connect to a database comprising a superset and/or more up-to-date version of the shipping rules stored in the computer. In addition, the hand-held computer may receive new or updated shipping rules from the article marker and/or a readable memory device which may be on the manifest (as described herein).

The shipping rules 36 may comprise actual “rules” established by the freight carrier or some other entity. For example, the shipping rules 36 may comprise a planned shipping itinerary for the article, with each rule representing one leg of the itinerary. However, the shipping rules 36 may also comprise objectives or guidelines related to the article of freight. For example, one shipping rule may be that the article be accompanied by a second article of freight. Another shipping rule may be that the article only be transported on certain types of transport vehicles. Yet another shipping rule may be that the article not be placed on the same transport vehicle having certain types of freight, such as poisonous or explosive materials. Furthermore, an individual shipping rule may comprise relatively complex logic. For example, a shipping rule may state that the article be transported to any one of five distribution centers.

The shipping rules 36, or a portion thereof, may also change as the article 12 is transported from the source location to the destination location. Once the article is transported from one distribution center to another, the shipping rules regarding its next destination may change. That is, the shipping rules 36 for an article 12 may be based, at least in part, on the current location of the article 12. For example, in order to transport the article 12 from the source location to the destination location, it may be possible for it to take a plethora of routes through various different cities. As the article 12 moves closer to its destination location, the number of possible routes for the article 12 may decrease accordingly, and the shipping rules 36 may reflect this change.

The shipping rules 36 may also take into account the time of day due to, for example, the timetable for transport vehicles. As an example, a shipping rule may be that an article is to be shipped on Truck A leaving at 3:00 pm; if the article is not able to be shipped on Truck A (e.g., due to not arriving in time, not being prepared in time, etc.), then the shipping rule may change so that the article is to be shipped on Truck B leaving at 6:00 pm. As another example, the shipping rules 36 may be based on the time of day so as to take into account the overall shipping schedule of the freight carrier. As such the shipping rules 36 may dictate on which transport vehicle the article is to be loaded and/or to which terminal the article is to be shipped. In short, it is contemplated that the shipping rules 36 may comprise many types of rules and/or objectives related to the article.

It is contemplated that movement of the article may be consistent with some shipping rules while, at the same time, be inconsistent with other shipping rules. As an example, if the article 12 is a food product intended for human consumption, one shipping rule may be to not place the article on a transport vehicle having freight containing a toxic substance. In this example, movement of the article may meet one shipping rule (e.g., a rule related to its itinerary or destination), but may not meet another shipping rule (e.g., placement of the article with toxic substances). The methods and systems described herein may be operable to indicate with which shipping rule (or rules) movement of the article is not consistent. In one embodiment, the system and method further comprises the ability to prioritize the conflicting rules to resolve or minimize the issue. This may comprise an algorithm to compare time stamps to decide which set of data should be utilized, etc.

The annunciator 28 may be operable to indicate to a human whether movement of the article to the second location is consistent with the one or more shipping rules 36. Accordingly, the annunciator 28 may receive a message from the computing device 30 which indicates whether movement of the article 12 is consistent with the one or more shipping rules related to the article. The message from the computing device to the annunciator may be transmitted via the communication link 32 or some other suitable link. In one embodiment, the annunciator 28 is integrated with the reader 24 such that the communication link 32 is used to transmit data from the reader to the computing device, as well as transmit messages from the computing device 30 to the annunciator 28.

The annunciator 28 is illustrated in FIG. 1 as being a visual device (e.g., a light). However, it is contemplated that the annunciator 28 may comprise many other types of devices as well. As examples, the annunciator 28 may comprise visual (e.g., lights), audio (e.g., sirens, buzzers), or tactile (e.g., vibration) devices or combinations thereof. More than one annunciator may be used. For example, a visual annunciator may be present on the video monitor of the computing device 30 or a dispatch office at the same time a visual or audible annunciator is present on the forklift 26. The annunciator 28 may be mounted on the lifting device (e.g., forklift 26), or it may be disposed at some other suitable location, such as proximate to the first or second locations, or on the person of a user. Furthermore, the annunciator 28 may be integrated into the reader 24 (as discussed above) or integrated into some other suitable device, such as a laptop computer, a desktop computer, a smart phone, a personal digital assistant, etc.

In addition to determining whether movement of the article 12 is consistent with one or more shipping rules, the system 10 may also perform other tasks as well. For example, if the second location is a transport vehicle, the user may also transmit information related to the physical condition of the transport vehicle to the computing device 30, which may store the information in the database 34. Also, the system 10 may be operable to generate a placard for the transport vehicle, based on the type of the articles loaded (which may be ascertained upon reading the article marker). As an example, the system 10 may generate a suitable placard if one or more of the articles of freight are a hazardous material. Furthermore, the system 10 may be operable to determine the space utilization of the transport vehicle. Information about the physical size of each article 12 may be associated with the article 12 and stored in the database such that, upon loading the transport vehicle, the system (by knowing the space capacity of the transport vehicle and by reading the article marker and ascertaining the article's size) may calculate the space utilization of the transport vehicle.

Similarly, the system 10 may be operable to determine whether there is overage or shortage for the transport vehicle. If an article is found on a transport vehicle but was not on the shipping manifest, the system 10 may be able to record this fact as well as record the identity of the article by receiving the article data from the article marker. This information may be stored in the database. On the other hand, if an article 12 is scheduled to placed on a transport vehicle (e.g., via a planned manifest) but is not (for various reasons) loaded onto that vehicle, the system may record this fact and store it in the database. As an example, after a transport vehicle is “closed” (i.e., after it has been loaded and its doors closed, or a logical equivalent), the system 10 may compare the planned manifest with the actual articles loaded, determine whether there is any shortage, and if so take appropriate action. The appropriate action may include sending a message to the annunciator which may alert the user loading the transport vehicle of the shortage, notifying a dispatcher, and so forth.

Upon reading the article marker 14, the system 10 may be configured to receive additional information about the article 12, such as photographs, notes, etc. As an example, the reader 24 may comprise a camera such that the camera takes a photograph of the article 12 anytime its article marker 14 is read. This may help the freight carrier determine whether and/or when the article 12 has been damaged. Alternatively, the system 10 may be configured to accept a photograph or other information about the article which may be input by a user when he/she reads the article marker 14 with the reader 24 (e.g., if the user notices the article is damaged). As a result, the transferring of the photograph and/or other information may be automatically done or may manually done by the user. Likewise, the system 10 may be configured to receive information about what particular action was taken by a person upon reading the article marker. If the system 10 determined that movement of the article was consistent with the shipping rules, the person may then notify the system whether he/she actually moved the article and, if so, to where the article was move. This feedback mechanism may allow the system 10 to determine the status of an article in real time. In an alternative embodiment, the article marker is capable of storing the additional information. For example, the article marker comprises a computer readable memory device and is capable of storing a photograph of the article. Or in another example, the article marker comprises a computer readable memory device and is capable of storing location data (e.g. geo-tagging) to create a location record of the article.

The system 10 of FIG. 1 may also be configured to ascertain the location of the transport vehicle if the transport vehicle is the first location, and a dock or distribution center is the second location. As used throughout the present application, dock is generically used to define a particular location. This location may include the location of the facility, the particular dock door/bay/slot, yard location, and the like. If the first location, second location, and article are all read by the reader 24 and the identifying information transmitted to the computing device 30, the system may associate the location of the transport vehicle (first location) with the dock or distribution center (second location). This may permit the system 10 to update the location of the transport vehicle in real time.

The system 10 may also be operable to generate a shipping manifest when, for example, the second location is a transport vehicle and after the article has been moved to the transport vehicle. This may take place when the transport vehicle is loaded (i.e., when the last article has been moved to the transport vehicle) and the transport vehicle is “closed.” Furthermore, upon loading a transport vehicle, the system 10 may be configured to determine whether the actual manifest (based on the articles actually loaded) and the planned manifest are different. If the actual and planned manifests are different, the system 10 may be configured to take a number of actions. First, the system 10 may transmit a message to the annunciator 28 indicating the planned manifest and actual manifest are different, and the annunciator 28 may be configured to display a suitable message. Second, the system 10 may permit the user to input a message (e.g., to the reader) explaining the difference in the two manifest. This message may be transmitted to the computing device where it may be stored in the database. Third, the system 10 may notify the user of the difference (e.g., via the annunciator) and allow the user to verify the difference actually exists or allow the user to correct the difference. Many other types of actions may be taken under these circumstances and, as indicated above, the system 10 may allow a “dialogue” to take place with the user in order to either explain or clear up the discrepancy.

Continuing with this example, the system 10 may be further operable to store in the database whether any support materials, such as load tables, were loaded onto the transport vehicle along with the article or articles. For example, certain article may necessitate the use of special packing and/or shipping materials. The system 10 may be configured to allow a person moving the article to record the use of these materials in the database. This may facilitate keeping track of these special packing and/or shipping materials.

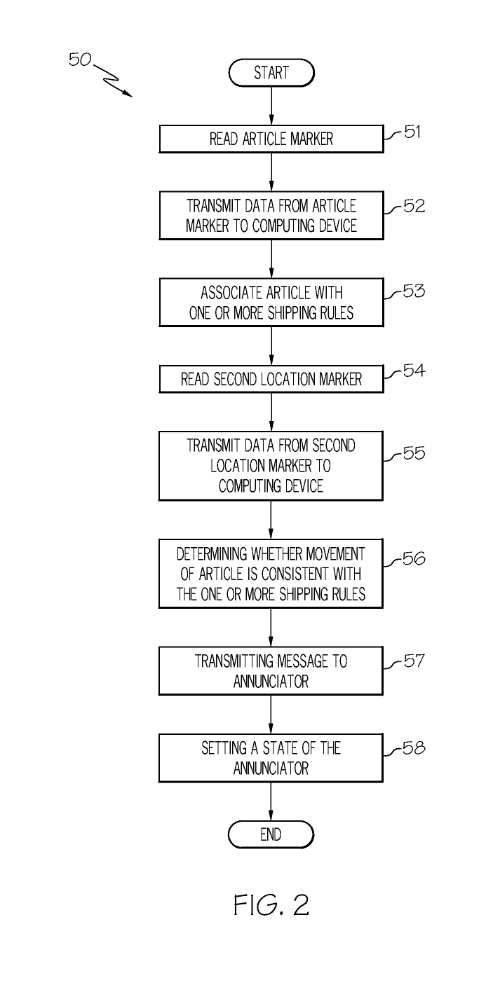

FIG. 2 depicts one embodiment of a method 50 which indicates whether movement of an article from a first location to a second location is consistent with one or more shipping rules. At act 51, the method reads an article marker comprising article data identifying the article. At act 52, the method transmits the article data to a computing device, wherein the computing device is in electrical communication with a database comprising one or more shipping rules related to the article. At act 53, the method associates the article, based on the article data, with the one or more shipping rules in the database. At act 54, the method reads a second location marker comprising second location data identifying the second location. At act 55, the method transmits the second location data to the computing device. At act 56, the method determines whether movement of the article to the second location is consistent with the one or more one or more shipping rules, based on the second location data. At act 57, the method transmits a message from the computing device to an annunciator, wherein the message indicates whether movement of the article to the second location is consistent with the one or more shipping rules. Finally, at act 58, the method sets a state of the annunciator, based on the message. It is not necessary that the acts of the method 50 be performed in any specific order. Furthermore, if multiple articles are to be moved from the first location to the second location, the method may only need to read the second location marker once since it is common to all the articles.

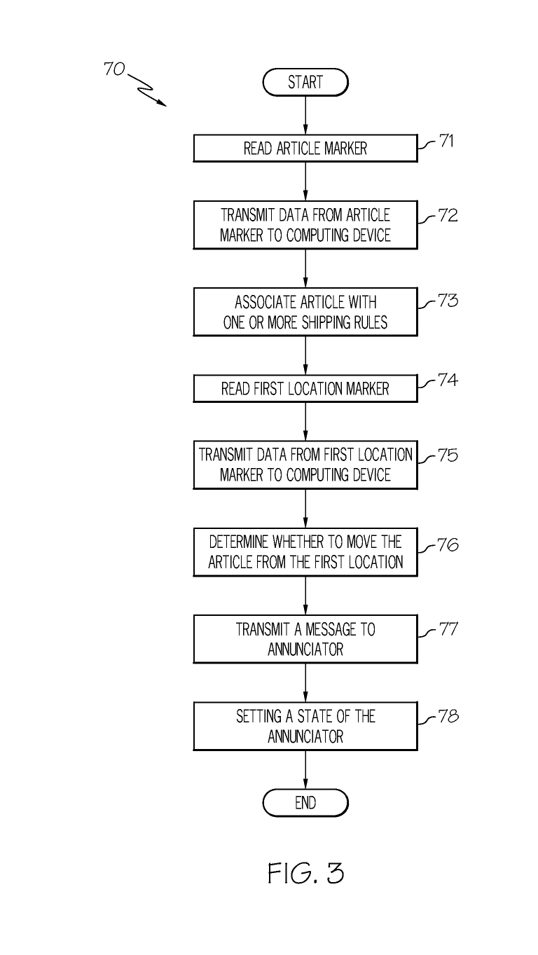

FIG. 3 depicts one embodiment of a method 70 for determining whether to move an article disposed at a first location. At act 71, the method reads an article marker comprising article data identifying the article. At act 72, the method transmits article data to a computing device, wherein the computing device is in electrical communication with a database comprising one or more shipping rules related to the article. At act 73, the method associates the article, based on the article data, with the one or more shipping rules in the database. At act 74, the method reads a first location marker comprising first location data identifying the first location. At act 75, the method transmits first location data to the computing device. At act 76, the method determines whether to move the article from the first location, based on the one or more shipping rules and the first location data, and wherein the associating is performed by the computing device. At act 77, the method transmits a message from the computing device to an annunciator, wherein the message indicates the determination of whether to move the article from the first location. Finally, at act 78, the method sets a state of the annunciator, based on the message. It is not necessary that the acts of the method 70 be performed in any specific order.

As an example of the method 70 depicted in FIG. 2, the first location may be a transport vehicle containing a plurality of articles. The transport vehicle may be located at a receiving dock, wherein some of the articles on the vehicle must be moved to the dock and some must remain on the vehicle (based on the shipping rules for each article). The method 70 may read a first location marker identifying the vehicle. The method 70 may further read each article and provide an indication to the operator (via the annunciator) whether each article is to be removed from the vehicle or remain on the vehicle. If an article is to be removed from the vehicle, the method 70 may further determine a second location (e.g., which dock or staging area) to move the article, based on the one or more shipping rules. The method 70 may then transmit the second location from the computing device to the annunciator and display the second location on the annunciator. In this fashion, an operator may, in real time, determine whether to unload an article from a transport vehicle and, if unloading, to where to move the article.

The method of FIG. 3 may also be operable to retrieve information 38 about the article which may be stored in the database 34. For example, the method may be operable to retrieve information 38 about whether the article of freight has a high priority. If the first location is a transport vehicle, the method may be able to determine whether the article was manifested on that transport vehicle. The method may also be operable to transmit information related to the physical condition of the transport vehicle to the computing device, which may store the information in the database.

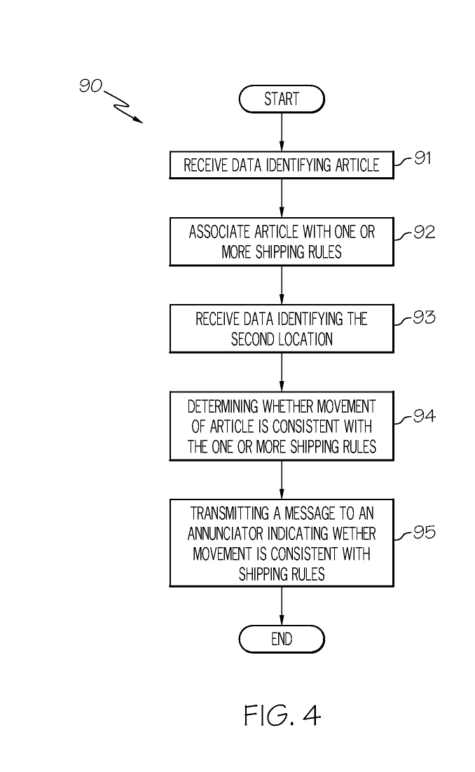

FIG. 4 depicts yet another embodiment of a method 90 for indicating whether movement of an article from a first location to a second location is consistent with one or more shipping rules. At act 91, the method receives into a computing device article data identifying the article, wherein the computing device is in electrical communication with a database comprising one or more shipping rules related to the article. At act 92, the method associates the article, based on the article data, with one or more shipping rules in the database. At act 93, the method receives into the computing device second location data identifying the second location. At act 94, the method determines, by the computing device, whether movement of the article to the second location is consistent with the one or more shipping rules, based on the second location data. Finally, at act 95, the method transmits a message from the computing device to an annunciator, wherein the message indicates whether movement of the article to the second location is consistent with the one or more shipping rules. It is not necessary that the acts of the method 90 be performed in any specific order.

The method 90 of FIG. 4 may be used in a client-server type of environment, wherein acts of the method 90 may be performed by a computing device (server). For example, a freight company (client) may transmit the article data and second location data to, and receive the message from a third-party (server). The third-party may be a non-freight company and may simply provide this service to the freight company. In this example, the server may be physically remote from the client.

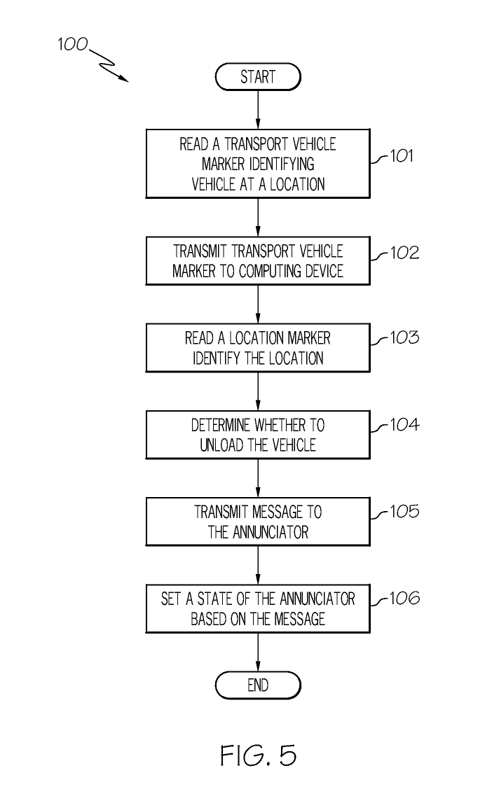

The method 100 of FIG. 5 depicts an embodiment for determining whether to unload a transport vehicle disposed at a location. At act 101, the method reads a transport vehicle marker comprising transport vehicle data identifying the transport vehicle. At act 102, the method transmits transport vehicle data to the computing device, wherein the computing device is in electrical communication with a database comprising one or more shipping rules related to the transport vehicle. At act 103, the method reads a location marker comprising location data identifying the location. At act 104, the method uses the computing device to determine whether to unload the transport vehicle, based at least in part on the one or more shipping rules and the location data. At act 105, the method transmits a message from the computing device to an annunciator, wherein the message indicates determination of whether to unload the transport vehicle. And at act 106, the method sets a state of the annunciator, based on the message.

The methods of FIGS. 2-5 may be performed in real time and may be performed in any suitable order. Similarly, if appropriate, the acts may be performed before, during, or after movement of the article. For the methods of FIGS. 2 and 5, the methods may be performed such that an operator knows in real time (by observing the state of the annunciator) whether movement of the article is consistent with the one or more shipping rules. The method of FIG. 3 may be performed such that the operator receives, in real time, the indication as to whether to move the article. In one embodiment, the article marker may be read at the time the article is picked up by the forklift. The second location marker (identifying the second location) may be read as the forklift approaches or enters the second location. In this fashion, the determination of whether the movement is consistent with one or more shipping rules may be determined while the article is being moved. Thus, the annunciator may warn the forklift operator that the movement is or is not consistent with the rule before the forklift operator places the article at the second location. The determination in real time may afford the freight carrier the ability to quickly correct any errors in movement of the article throughout its itinerary. As discussed herein, the acts of the methods may be performed in any suitable order. For example, the second location marker may be scanned before the article marker, and so forth.

As an example of the method of FIGS. 2 and 5, the freight carrier may desire to transport an article of freight from a sender in Chicago to a receiver in Los Angeles. The shipping rules may comprise the desired itinerary of the article. For example, one shipping rule may be to pick up the article from the sender and transport it to the Chicago regional distribution center. Another shipping rule may be to transport the article from the Chicago regional distribution center to the Denver regional distribution center. Still, another shipping rule may be to transport the article from the Denver regional distribution center to the Los Angeles regional distribution center, and so forth.

Referring back to FIG. 1, assume for the above example that the article 12 is located at the Chicago regional distribution center and must be transported onto a truck going to Denver. The first location may be the Chicago regional distribution center (or its dock), and the second location may be the truck going to Denver. In order to move the article toward its destination, the freight carrier may pick up the article 12 on the dock with a forklift 26 and move the article to the transport vehicle. According to one embodiment of the method, the forklift 26 may be operable to read the article marker 14 on the article 12 (with reader 24) and transmit information from the article marker to a computing device 30. Using the information from the article marker 14, the computing device 30 may associate the article 12 with one or more shipping rules 36 stored in a database 34. In this example, the computing device 30 may associate the article with one shipping rule requiring the article be placed on a transporting vehicle traveling to Denver. As the forklift moves the article 12 to the transport vehicle, the forklift 26 may be operable to read the second location marker 22 at the second location 20 (i.e., at the transport vehicle) and transmit information from the second location marker to the computing device 30. The information from the second location marker may identify the transport vehicle and whether it is traveling to Denver. Based on information from the second location marker, the computing device 30 may be able to determine whether movement of the article 12 from the dock (first location) to the transport vehicle (second location) is consistent with the shipping rule that the article be transported to Denver. The method may indicate to the forklift operator (via an annunciator 28) whether movement of the article 12 is consistent with this shipping rule.

In a variation on the above example, the article 12 may need to be transported from the Chicago regional distribution center to the Los Angeles regional distribution center. However, instead of having just one itinerary (i.e., via Denver), the article 12 may have a multitude of itineraries which permits the article to be transported to Los Angeles. For example, acceptable itineraries may permit the article to be transported to Los Angeles via the Denver, Houston, or Salt Lake City regional distribution centers. In this case, the shipping rules 36 for the article 12 may comprise all of these itineraries such that transporting the article to any of these intermediate locations is consistent with the one or more shipping rules 36. Furthermore, the shipping rules may change as the article progresses toward its final destination. While the article is in Chicago, a shipping rule may be to transport the article to Denver, Houston, or Salt Lake City. However, if the article is transported to Salt Lake City, the shipping rules may change such that shipping the article to Houston is no longer considered a “shipping rule.”

The systems and methods described herein may also permit statistics to be collected regarding movement of articles. As an example, when an article is moved from a first location to a second location, the time may be noted when the article leaves the first location and when the article arrives at the second location, such that the elapsed time to move the article may be calculated. This information may permit the freight company to collect information regarding the efficiency of its operations. For example, the average amount of time to load an article (based on its weight, its size, the dock location, etc.) may be calculated. As another example, the efficiency of a particular employee may be ascertained. Other types of statistical information may be collected as well such as, for example, dwell time. In order to facilitate the collection of this type of data, the system may be able to also receive the identify of the person moving the article or performing some other operation (e.g., weighing or inspecting the article) so that the system can identify the person associated with a particular action. The system may be able to receive the person's identity via manual entry of the person's name or employee number, or via an automatic scan of an electronic or magnetic identification tag. Other ways of identifying the person may be used as well. For example, a person may be required to enter identification data into the reader upon starting a shift, or alternatively upon each reading of article data.

It should now be understood that the systems and methods described herein may be used to automatically identify articles shipped by a freight carrier. This identification may be used to determine whether movement of the article is consistent with one or more shipping rules.

While particular embodiments and aspects of the present invention have been illustrated and described herein, various other changes and modifications may be made without departing from the spirit and scope of the invention. Moreover, although various inventive aspects have been described herein, such aspects need not be utilized in combination. It is therefore intended that the appended claims cover all such changes and modifications that are within the scope of this invention.

What is claimed is:

1. A method for determining whether to move an article disposed at a first location, the method comprising:
reading an article marker comprising article data identifying the article;
transmitting article data to a computing device, wherein the computing device is in electrical communication with a database comprising one or more shipping rules related to the article;
using the computing device to associate the article, based at least in part on the article data, with the one or more shipping rules in the database;
reading a first location marker comprising first location data identifying the first location;
transmitting first location data to the computing device;
using the computing device to determine whether to move the article from the first location, based at least in part on the one or more shipping rules and the first location data;
transmitting a message from the computing device to an annunciator, wherein the message indicates determination of whether to move the article from the first location; and setting a state of the annunciator, based on the message.

2. The method of claim 1, wherein the article marker further comprises at least one of the one or more shipping rules related to the article, and the method further comprises:
reading the article marker comprising the one or more shipping rules; and
transmitting at least one of the one or more shipping rules to the computing device.

3. The method of claim 2, wherein the article marker is configured to receive and store at least one of the one or more shipping rules, and the method further comprises transmitting at least one of the one or more shipping rules to the article marker, such that the at least one of the one or more shipping rules is stored on the article marker.

4. The method of claim 1, wherein upon determining the article is to be moved from the first location, the method further comprises:
determining a second location to move the article, based at least in part on the one or more shipping rules;
transmitting the second location from the computing device to the annunciator; and
displaying the second location on the annunciator.

5. The method of claim 1, further comprising:
transmitting a first time stamp to the computing device indicating a time when the first location marker is read;
reading a second location marker comprising second location data identifying a second location;
transmitting the second location data to the computing device;
after the article is moved to the second location, transmitting a second time stamp to the computing device indicating a time when the second location marker is read; and
using the computing device to determine an elapsed time for movement of the article, based on the first time stamp and the second time stamp.

6. The method of claim 1, further comprising:
determining whether the article has a high priority, based at least in part on the one or more shipping rules;
transmitting an indication of the high priority from the computing device to the annunciator; and
displaying the indication on the annunciator.

7. The method of claim 1, wherein the first location is a transport vehicle, and the method further comprises:
transmitting to the computing device additional information related to physical condition of the transport vehicle; and
storing the additional information related to physical condition of the transport vehicle in the database.

8. A method for determining whether to unload a transport vehicle disposed at a location, the method comprising:
reading a transport vehicle marker comprising transport vehicle data identifying the transport vehicle;
transmitting transport vehicle data to the computing device, wherein the computing device is in electrical communication with a database comprising one or more shipping rules related to the transport vehicle;
reading a location marker comprising location data identifying the location;
using the computing device to determine whether to unload the transport vehicle, based at least in part on the one or more shipping rules and the location data;
transmitting a message from the computing device to an annunciator, wherein the message indicates determination of whether to unload the transport vehicle; and setting a state of the annunciator, based on the message.
